(19) United States
(12) Patent Application Publication
(10) Pub. No.: US 2017/0319906 A1
(43) Pub. Date: Nov. 9, 2017

(54) TORQUE APPARATUS FOR EXERCISE EQUIPMENT

(71) Applicant: Peloton Interactive, Inc, New York, NY (US)

(72) Inventors: Yao-Jen Chang, Taichung City (TW); Chen-Fei Yang, Taichung City (TW)

(21) Appl. No.: 15/588,566

(22) Filed: May 5, 2017

(30) Foreign Application Priority Data
May 9, 2016 (CN) 201610300761.8

(51) Int. Cl. A63B 24/00; A63B 21/22; A63B 22/06; G01L 3/10

(52) U.S. Cl. CPC A63B 24/0087; G01L 3/104; A63B 21/225; A63B 22/0605; A63B 2220/54

(57) ABSTRACT

A resistance apparatus for exercise equipment includes a resistance adjusting unit and a sensor unit. The resistance adjusting unit includes an adjusting member, a tubular sleeve located above the adjusting member, an adjusting shaft disposed in the tubular sleeve. A first threaded nut is pivotally mounted to the adjusting member and threadedly connected to the adjusting shaft. The sensor unit has a moveable member, a second threaded nut, a first sensing member and a second sending member. One end of the moveable member is pivotally mounted to the adjusting Member. The second threaded nut is threadedly connected to the adjusting shaft and moveable member. The sensing members are disposed on the other end of the adjusting member and the moveable member, respectively. Thereby, a distance between the sensor and the sensing member is changed with respect to the corresponding movements of the first and second threaded nuts on the adjusting member and the moveable member for generating corresponding sensing signals.

### CROSS-REFERENCE TO RELATED APPLICATION

This application claims priority to Chinese patent application number 201610300761.8, filed May 9, 2016, the entire contents of which are incorporated herein by reference.

### TECHNICAL FIELD

The present application relates generally to the field of exercise equipment and methods, and more specifically to systems and methods for sensing and/or adjusting resistance in exercise equipment.

### BACKGROUND

Modern fitness equipment is often configured to allow users to adjust the equipment according to their own training needs. The adjustment operation in some fitness equipment is difficult and cumbersome for many users. For example, an exercise bicycle may be configured with a torque regulator, allowing users to adjust the pedal resistance by adjusting a degree of torque to be applied to a flywheel. However, conventional adjustment approaches can take a long time to accurately set, inconveniencing the user. There is therefore a need for improved systems and methods for operating exercise equipment that increases the convenience to the user and enhances the exercise experience.

### BRIEF DESCRIPTION OF THE DRAWINGS

Aspects of the disclosure and their advantages can be better understood with reference to the following drawings and the detailed description that follows. It should be appreciated that like reference numerals are used to identify like elements illustrated in one or more of the figures, wherein showings therein are for purposes of illustrating embodiments of the present disclosure and not for purposes of limiting the same. The components in the drawings are not necessarily to scale, emphasis instead being placed upon clearly illustrating the principles of the present disclosure.

FIG. 1 is a perspective view of an exemplary embodiment of a torque sensing apparatus.

FIG. 2 is a partial plan view of an exemplary embodiment of a torque sensing apparatus.

FIG. 3 is a partial plan view of an exemplary embodiment of a torque sensing apparatus.

### DETAILED DESCRIPTION

In accordance with various embodiments of the present disclosure, systems and methods for sensing and adjusting torque in exercise equipment are provided.

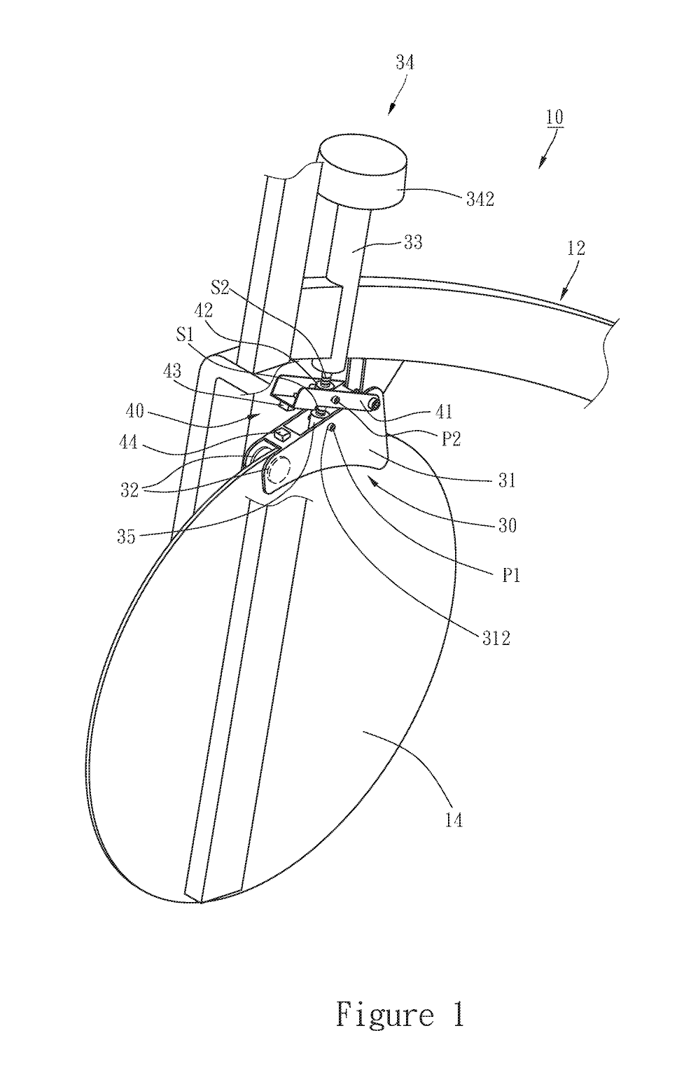

Referring to FIGS. 1-3, an exemplary embodiment of a torque sensing apparatus will now be described. In the illustrated embodiment, a torque sensing apparatus 10 is provided for an exercise bicycle that can reduce the adjustment effort and shorten the sensing time, thereby increasing the convenience of the operation for the user. The torque sensing apparatus 10 includes a torque adjusting unit 30 and a sensing unit 40. The torque adjusting unit has an adjusting member 31, a tubular sleeve 33, an adjusting shaft 34, and a first threaded nut 35. The adjusting member 31 is disposed around a periphery of a flywheel 14, with one end of the adjusting member 31 pivotally mounted to the frame 12 of a bike, such as a stationary spinning bike. The tubular sleeve 33 is disposed on the frame 12 and is located above the adjusting member 31. The adjusting shaft 34 passes through the tubular sleeve 33 and has a first threaded portion S1 and a second threaded portion S2 formed thereon. The threads of the first threaded portion S1 and the second threaded portion S2 extend in opposite directions. The first threaded nut 35 is threaded to the first threaded portion S1 of the adjusting shaft 34. The first threaded nut 35 is pivotally engaged with the first threaded portion S1 thereby driving the adjusting member 41 against the flywheel 14, up and down.

The sensing unit 40 has a movable member 41, a second threaded nut 42, a first sensing member 43 and a second sensing member 44. One end of the movable member 41 is pivotally mounted to the adjusting member 31. The second threaded nut 42 is threaded to the second threaded portion S2 of the adjusting shaft 34 and is pivotally connected to the movable member 41. The first sensing member 43 and the second sensing member 44 are correspondingly disposed on the movable member 41 and the adjusting member 31, respectively.

By rotating a rotatable knob 342 disposed on one end of the adjusting shaft 34, the adjusting shaft 34 is rotatably driven and the first threaded nut 35 and second threaded nut 42 are driven to axially move up and down along the first threaded portion S1 and the second threaded portion S2 of the adjusting shaft, respectively.

When the first threaded nut 35 is moved, the adjusting member 31 is biased relative to the flywheel 14, such that the magnetic flux between two magnetic members 32 is changed, providing resistance to the flywheel. When the second threaded nut 42 is moved, the movable member 41 is biased relative to the adjusting member 31, because the first threaded portion S1 and second threaded portion S2 have opposite threads. When they are rotatably driven by the adjusting shaft 34, the first threaded nut 35 and second threaded nut 42 are driven to orient toward or away from each other such that a distance between the first sensing member 43 and second sensing member 44 is changed, generating sensing signals to a control panel for allowing the user to acquire the changes in resistance value. In one embodiment, one of the first sensing member and second sensing member is sensor adapted to sense proximity from the other sensing member (for example, a Hall sensor and a magnet).

In view of the foregoing, it can be seen that the torque sensing apparatus 10 of the present embodiment includes the first threaded portion S1 and second threaded portion S2, arranged to allow the adjustment member 31 and the movable member 41 to utilize the opposite threading to change the distance between the first sensing member 43 and the second sensing member 44. In this arrangement, the sensing members output a corresponding sensing signal thereby reducing the stroke and shortening the sensing time for the user.

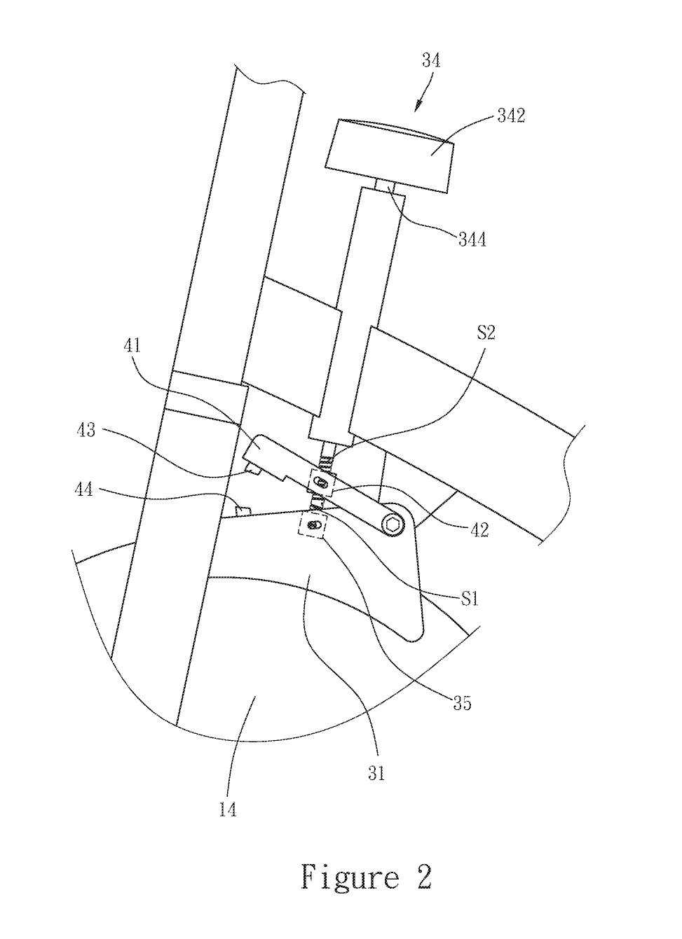

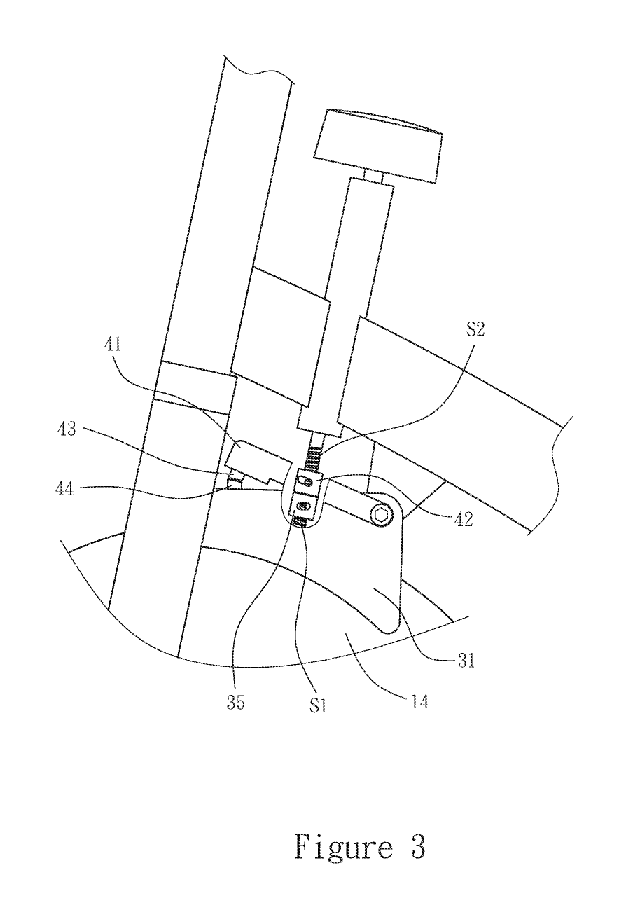

Additional details will now be described with reference to the figures. FIG. 1 is a perspective view of the present embodiment. FIG. 2 is a partial plan view of the present embodiment, showing the first sensing member 43 and the second sensing member 44 being remote from each other. FIG. 3 shows the sensing member 43 and sensing member 44 in a close state.

Referring first to FIG. 1, an exercise cycle includes the frame 12 and a flywheel 14 operably connected to allow a user to rotate the flywheel as the user pedals the exercise cycle. As shown in FIG. 1, the torque adjusting unit 30 includes an adjusting member 31 that is connected to the cycle frame 12 at one end. The adjusting member 31 also includes holes formed on opposite sides of the adjusting member 31 that form a long hole 312. The magnets 32 are disposed inside the adjusting member 31 and are maintained a predetermined distance from the flywheel 14. The first threaded nut 35 is screwed to the first threaded section S1 of the rod portion 344 of the adjusting shaft 34. The two opposite sides of the first nut 35 are pivotally mounted in the middle of the adjusting member 31 by a first pivot P1, displaceably mounted in the long hole 312 of the adjustment member 31.

Referring to the sensing unit 40, the moveable member 41 and the rear end of the adjusting member 31 are pivotally mounted on the frame 12 in a coaxial manner. The second threaded section S2 of the screw portion 344 of the adjusting shaft 34, and the second pair of opposite sides of the second threaded nut 42 are pivotally connected to an intermediate position of the moveable member 41 by a second pivot P2, respectively.

As shown in FIGS. 2 and 3, when the knob 342 is rotated, the adjusting shaft 34 is driven via the first threaded portion S1 and the second threaded portion S2 of the screw portion 344, respectively. The first threaded nut 35 and the second threaded nut 42 are vertically displaced along the axial direction of the adjusting rod 34. The first threaded nut 35 will cause the adjustment member 31 to move relative to the flywheel 14 so that the adjustment member 31 is able to utilize the magnetic flux change between the two magnets 32 and the flywheel 14. During displacement of the second threaded nut 42, the movable member 41 is deflected with respect to the adjustment member 31. Because the first and second threaded portions S1, S2 have opposite threads, the first threaded nut 35 and second threaded nut 42 are driven closer to or away from each other by the adjustment shaft 34. In this manner, between the sensing element 43 and the sensing element 44 the distance between the first sensing member 43 and second sensing member 44 changes relative to the movement of the moveable member 41 and the adjusting member 31. As the distance changes, the sensing element 43 (or sensing element 44, in various configurations) can generate a corresponding sense signal to a control panel allowing the user to know the torque based on the message displayed on the control panel.

In view of the above, the torque sensing apparatus 10 of the present embodiment utilizes the first threaded portion S1 and second threaded portion S2 to allow the adjustment member 31 and the moveable member 41 to utilize the first threaded nut 35 and second threaded nut 42 to change the distance between the first sensing member 43 and the second sensing member 44. Advantages of the present embodiment will be apparent to those skilled in the art, including that the present embodiment can effectively achieve the reduction of user action and shorten the sensing time.

The foregoing disclosure is not intended to limit the present invention to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize advantages over conventional approaches and that changes may be made in form and detail without departing from the scope of the present disclosure. Thus, the present disclosure is limited only by the claims.

What is claimed is:

1. A torque sensing apparatus for an exercise cycle having a frame and a flywheel, the torque sensing apparatus comprising:
a torque adjusting unit having an adjusting member, a sleeve attached to the frame, an adjusting rod disposed within the sleeve, and a first nut, wherein the adjusting member is disposed on a peripheral edge of the flywheel, wherein the adjusting rod has a first threaded portion and a second threaded portion, the second threaded portion having threads opposite the rotation of the first threaded portion, wherein the adjusting member is attached to the frame at one end and includes a first sensing member adjacent to the opposite end of the adjusting member, and wherein the first nut is attached to the adjusting member and threadedly coupled to the first thread portion of the adjustment rod; and
a sensing unit having a moveable member, a second nut, and a second sensing member, wherein one end of the moveable member is pivotally connected to the torque adjusting unit at one end, wherein the second sensing member is disposed on the moveable member adjacent to the opposite end, wherein the second nut is threadedly coupled to the second threaded portion of the adjusting rod and attached to the moveable member, and wherein the first sensing element and the second sensing element correspond to each other to produce a sensing signal representative of the torque adjustment.

2. The torque sensing apparatus according to claim 1, wherein the first nut is pivotally connected by two opposing pivots on each side of the adjusting member, wherein the adjusting member includes a through hole wherein each of the pivots is displaceably mounted in the through hole.

3. The torque sensing apparatus according to claim 1, wherein the sensing element is provided in a linkage block of the adjustment member.

4. The torque sensing apparatus according to claim 1 wherein the sensing element is provided in the adjusting member.

5. The torque sensing apparatus according to claim 1 wherein the first sensing element is a Hall sensor, and the second sensing element is a magnet.
